(19) United States
(12) Patent Application Publication
(10) Pub. No.: US 2010/0251092 A1
(43) Pub. Date: Sep. 30, 2010

(54) Method and System for Processing Fixed Format Forms Online

(76) Inventor: Jun-Shi SUN, Sharon, MA (US)

Correspondence Address: K.P. CORRELL AND ASSOCIATES, L.L.P., 270 BELLEVUE AVE., #326, NEWPORT, RI, 02840, US

(21) Appl. No.: 12/411,182

(22) Filed: Mar. 25, 2009

(51) Int. Cl. G06F 17/00

(52) U.S. Cl. 715/222; 715/221; 715/235

(57) ABSTRACT

A form processing system for processing electronic forms (e-form) forms while preserving the e-form fixed format is provided. The form processing system includes three functional modes or subsystems: the design mode, the edit mode and the view mode. The system, in design mode, designs form templates, manages permission and sets up dynamic workflow parameters. In the view mode, the form is read-only. The form looks like a regular PDF document. This mode is used for exporting data to e-form, printing form and sharing form by multiple users.

### FIELD OF THE INVENTION

This invention relates to the field of processing forms on the Internet or world-wide-web.

### BACKGROUND OF THE INVENTION

Forms are an important tool for collecting, storing and presenting information. A form can be either on the paper, or in an electronic format such as PDF (Portable Document Format), MS Word, Excel, InfoPath, XFDL (Extensible Forms Description Language) or HTML. Due to the advantages of electronic forms (e-forms) such as lower cost and higher efficiency, e-forms have become more and more popular. The U.S. federal government has mandated that, by 2003, all agencies offer their forms electronically as well as in paper by the Government Paperwork Elimination Act (GPEA). Unfortunately, there has not been an ideal way to help the government to fulfill this goal. At this time, the solution for GPEA is to provide fillable PDF forms, which can be created with Adobe Acrobat Professional, on many government web sites.

PDF is presently the most popular e-form format. The PDF Reader is free to download. It is portable across platforms. It provides a SDK (Software Development Kit) for developing advanced features. The main limitation is that no browsers are capable of processing PDF documents. When a PDF file is loaded from the Internet, the browser just passes the control to the add-on PDF component.

PDF is a file format, not a forms processing system. The ‘lifecycle’ of processing a PDF form may include:
Find a form on the Internet with a browser.
Fill the form in one of three ways:
   Fill the form with a PDF Writer.
   Fill the form with a PDF Reader if it is fillable.
   Print the form on paper and fill the form
Print the form on paper. Submit the form by mail, fax or hand it in directly.
Pass to different parties for approval if the form contains sections to be approved by one or more parties.
The form can be returned for missing or incorrect information.
Key-in the information on the form into a database through a database interface.
   The whole process may take days or even weeks.

More efficient web-based forms processing applications can display HTML forms in a web browser, pre-fill some fields such as fields for personal information. These applications can also validate the user input and save the forms online. Examples of such applications are the college application web site (https://app.commonapp.org, U.S. Pat. No. 6,460,042, U.S. Pat. No. 6,345,278), and the TurboTax Online site (http://turbotax.intuit.com/personal-taxes/). These applications are built with HTML forms along with the server-side programming with languages such as JAVA, C# or VB.NET, and the client-side programming with JavaScript and Cascading Style Sheets (CSS). Many of these HTML applications are database-based. This type of dedicated WEB application is developed for special purposes and is not reusable. The cost for development and maintenance (changing forms) is very high. For these reasons, some general-purpose HTML forms applications such as OneFormPlus by Amgraf, Inc. (http://www.amgraf.corn/) have been developed.

There are some problems which are common to all HTML form applications.
Unlike paper-based forms or other e-forms such as PDF, HTML forms are not page-based. When printing an HTML form, it breaks the content into pages in an unpredictable way.
The HTML forms with HTML controls, such as TextBox and RadioButton, look very different from forms on paper.
The hidden content in controls with scroll-bars such as in a TextBox or a Table (grid) can be viewed in a browser, but not on the printout.
Lack of fixed format. The appearance of a WEB page is affected by screen resolution, font-size and browser window size.
The HTML documents are not ‘What you see is what you get (WYSIWYG’) for printing.

Due to the problems listed above, the HTML form application so far is not an ideal replacement for forms on paper or e-forms designed for paper. A fixed format is critical for many forms such as legal documents.

To overcome the format problem, some software systems such as Adobe LiveCycle ES, IBM Lotus Forms and Microsoft SharePoint/InfoPath adapted a different approach. These systems use file-based forms in their proprietary format and usually contain a form designer, a client software and a form server which can be accessed through the client software or through a WEB browser via a WEB server as shown, for example, in U.S. Pat. No. 7,313,757.

The form designer is used to design form templates which are saved on the form server as XML files. The form templates can be retrieved with the client software with which the user can fill and submit the forms to the form server. Printing forms as displayed on the screen is not a problem for client/server based client software. The form template can also be converted to HTML format for the user to process online with a web browser. These systems also have more advanced enterprise features such as data calculation and validation, security checking, digital signature, routing and workflow etc. However, this type of systems has the following disadvantages:
Compared to database-based systems, file based systems are:
   Limited in the ability to store and process forms in its proprietary format;
   Less efficient for extracting and manipulating data;
   Difficult to be integrated with other software systems because most software applications, such as client/server and WEB based, are database based;
   Less secure during workflow for file based forms if they are not encrypted;
   Difficult to implement role-based workflow and to divide the form into multiple levels and/or sub-levels;
   Unable to process forms in a parallel way at any stage of the workflow.
Difficult to implement partial form completion (automatically fill all or some form fields) for multiple users.
Not regular WEB application. Special forms server are required. While it is possible for the forms server to render the form to HTML form and send it to the user's browser via a WEB server, the HTML form has the same problems as we have discussed for the HTML WEB form applications. Adobe LiveCycle ES can also send PDF forms to the browser. But an Adobe Reader or Writer is required for viewing the PDF form, and server-side programming is required for sending and retrieving a PDF form.

Some prior inventions use scanned images as the background, see, for example, U.S. Pat. No. 7,171,615. The loading speed is slow for High resolution images due to the large file size; the display and printout quality is low for low resolution images.

The WEB-based applications using an image as background have additional problems besides the ones with the standard HTML applications. The HTML controls such as RadioButton, ComboBox and Table (or Grid) significantly change the look of the background image, and make using a background image less meaningful. In addition, web browsers cannot print a full-page image on a single piece of paper of the same size even if all margins are set to zero. While it is possible to print completed forms with a client/server application, the printout is not directly available for remote users.

The WEB-based applications above also did not address some advanced features for form processing such as role-based security and information privacy, workflow, partial form completion, integration with other WEB systems, processing forms in group, conditional input, and dynamic page and form.

### SUMMARY OF THE INVENTION

While overcoming the shortcomings discussed above, the present invention also implements new features such as input dependency, dynamic pages and processing forms in a group. An example for input dependency is the U.S. tax form W-9 form (Request for Taxpayer Identification Number and Certification) (not shown). A user should not be able to enter anything in the field to the right of “Other” if “Individual/Sole proprietor” or “Corporation” or “Partnership” is checked. In some forms, dependency could be applied to sections. Dynamic pages is a feature for the user to add additional pages if the form does not have enough space for the content the user needs to enter. Processing forms in a group and not allowing submission unless all required forms in the group are completed make forms management easier. The present invention also provides a simple way to integrate this system with other web applications.

This invention is a system for processing forms on the World Wide Web. The invention uses, for example, an empty PDF form as the input, displays the image of a PDF form one page as a time as the background in a web page. The page images are generated by the page object of the PDF SDK to insure an identical look with the one in the PDF Reader/writer. It will be understood that any suitable form format and its associated SDK may be used.

The invention contains three functional modes or subsystems: the design mode, the edit mode and the view mode. Instead of using a special type of form such as PDF or MS Word, the invention converts the form documents to image files and uses the images as the background layer. The invention displays one page image of a PDF file, for example, at a time, and allows the entering of data on a separate layer which is overlaid over the image. The three modes can be implemented either as web or client/server applications.

The design mode is used to design form templates, manage permission and set up dynamic workflow. In this mode, a form page image is displayed as the background, the input controls such as TextBox, ComboBox, CheckBox, RadioButton and Grid can be placed, moved and resized by drag/drop on top of the image background. The control properties such as font family, font size, text alignment, Enabled and Visible can be set or changed. A control can be bound to a field of a data table or database view. This allows the user to insert or update data in the database. A control can have a default value from a database table. For example, many forms require personal information. The controls for personal information can retrieve values from tables commonly named as Users or Employees. A control's content can be a function of contents of other controls. This allows the form to have spreadsheet like functionality. An unbound control can be assigned a value and serves as a constant in the function. A form can be divided into multiple processing sections based on the workflow. We can also group multiple forms into an ‘Application’. Forms in an application can be submitted only if all forms have been completed.

The edit mode is used to enter data, add annotation and attachments, and assign users for form preparation. In the edit mode, the controls on the image background are used for data entry. For the web implementation of the edit mode, the user can enter, update and save data directly on a web page with the form image as the background. For forms containing multiple processing sections, the workflow is divided into multiple levels and sub-levels. Only one sub-level can be processed at any time for a user. Controls in other sub-levels are read-only. Implementation may use a colored background indicating editable controls. Data validation is performed in the edit mode. It will be appreciated that no browser PDF add-ons is required because it is the images, instead of the PDF file displayed on the web pages, that are displayed in accordance with the teachings of the present invention.

This system makes it possible to process forms on the web with the same look as forms on paper because the images preserve the look of the form, and the data controls are saved and displayed at the coordinates relative to the images. No programming or form text editing is required to bring forms online. Thus, the invention greatly shortens the form processing ‘lifecycle’, and greatly reduces the cost for building and maintaining web applications for form processing.

In the view mode, the form is read-only. The background color and the look of the input controls are not presented. The form looks like a regular PDF document. This mode is used for exporting data to e-form, printing form and sharing form by multiple users.

In accordance with one embodiment of the present invention a form processing system for processing electronic forms (e-form) forms while preserving the e-form fixed format is provided. The form processing system includes a repository subsystem, a designer subsystem for designing form templates, managing permissions and assigning workflow to at least one form designer associated with the e-form, and a form processor subsystem. The repository subsystem includes an image repository for containing page images having a plurality of e-form static data fields. Also included is a system data repository for storing dynamic data fields designed by the designer subsystem where each of the dynamic data fields has at least a one-to-one correspondence with the e-form static data fields and form the data layer. The form processor subsystem also includes an edit subsystem for editing properties of the dynamic data fields. The form processing system also includes a viewing subsystem for viewing the e-form page image and the data layer; where each of the dynamic data fields having a one-to-one correspondence with an e-form static data fields is visually overlayed with its corresponding e-form static data field.

In accordance with another embodiment of the present invention a system for generating a plurality of dynamic data field objects corresponding to a plurality of static data fields in fixed electronic forms (e-form) is provided. The system includes a template designer subsystem for generating a data layer having a plurality of dynamic data field objects. Each of the plurality of dynamic data field objects has a one-to-one correspondence with each of the plurality of e-form static data fields to form the data layer. The system also includes a repository subsystem comprising an image repository for containing the form images. In addition, the system includes a form processor subsystem having an editing subsystem for entering data and executing workflow and a viewing subsystem for viewing the e-form static data fields and the at least one object image data layer; wherein each of the dynamic data field objects having at least a one-to-one correspondence with each of the e-form static data fields is visually overlayed with its corresponding e-form static data field.

The invention is also directed towards a method for processing fixed electronic forms (e-form) having a plurality of static data fields. The method includes generating an image replica of the e-form having static data fields and generating dynamic data field objects corresponding with one or more of the static data fields. Each of the dynamic data field objects may be assigned one or more than one: control parameters; security parameters; workflow parameters; and e-form coordinates corresponding to its corresponding e-form static data field object. Each of the dynamic data field objects is processed according to its associated parameters, e.g.; dynamically enabling/disabling each subset of the dynamic data field objects in a sub-level according to its associated workflow parameter; populating each of the dynamic data field objects with an associated default value; and generating an electronic notification when the dynamic data field process is complete. In addition, the method includes displaying the image replica and each of the plurality of dynamic data field objects according to its at least one e-form coordinate.

### BRIEF DESCRIPTION OF THE DRAWINGS

Other features and advantages of the invention will become more apparent upon study of the following description taken in conjunction with the drawings in which:

FIG. 1 discloses features and components of the present invention;

FIG. 2 discloses the workflow for creating a form template in accordance with the teachings of the present invention shown in FIG. 1;

FIG. 3 shows a user interface for editing a form template in accordance with the teachings of the present invention shown in FIG. 2;

FIG. 4: shows an interface for setting default values in accordance with the teachings of the present invention shown in FIG. 3;

FIG. 5 discloses the structure and relation of a data table for roles and permissions in accordance with the teachings of the present invention shown in FIG. 1;

FIG. 6 discloses a sequential and parallel dynamic workflow model of a form instance in accordance with the teachings of the present invention shown in FIG. 1;

FIG. 7 discloses an example single user sign-on implementation in accordance with the teachings of the present invention shown in FIG. 1;

FIG. 8 discloses example server-side script for rendering a forms processor HTML page in accordance with the teachings of the present invention shown in FIG. 1;

FIGS. 9a-9c discloses a HTML page's initialization and event handling of the form processor in accordance with the teachings of the present invention shown in FIG. 1r;

FIG. 10 discloses one method for handling form object dependency in accordance with the teachings of the present invention shown in FIG. 9;

FIG. 11 discloses a process for generating a filled PDF template for printing in accordance with the teachings of the present invention shown in FIG. 1;

FIG. 12 discloses a process for saving form record of a completed or uncompleted form instance in accordance with the teachings of the present invention shown in FIG. 1; and

FIG. 13 shows an example screen-shot of a web page of the forms processor in accordance with the teachings of the present invention shown in FIG. 1.

### DETAILED DESCRIPTION OF PREFERRED EMBODIMENTS OF THE INVENTION

The invention disclosed herein describes processing electronic forms (e-forms) such as, for example, PDF forms online, and handling complicated dynamic workflow. It will be appreciated that the invention significantly improve many aspects of forms processing disclosed in the prior art. It will be understood that dynamic data fields or objects are fields described herein correspond to static data fields represented in the online e-form or fixed format form. It will be understood that static data fields are those fields on a form, online or otherwise, often referred to as form fields and are the blank areas where data is usually entered or represented. Further, it will be understood that the dynamic data field objects generated herein may be assigned suitable control properties, security parameters, workflow parameters, and location coordinates corresponding to a static data filed represented in the online form. It will also be understood that object, in modern computer science, has properties, methods and events and that properties make an object different from other objects. The term parameter used herein is used for any properties or settings.

The invention processes form information with the form template which contains a set of controls superimposed on the form image background. The template also contains database connections, data validation and other business rules.

The current invention uses form image as background and superimposes a data layer on top of the image.

The invention has three modes: the design mode is for designing the template, managing permission and configuring workflow; the edit mode is for data entry, adding annotations and attachment. The view mode is read-only. It shows the final look of the form for reviewing and printing.

The current invention defines a software tool as a template designer if it contains the design mode of the system. A designer can optionally contain the edit mode and the view mode. A software tool may also be defined as a form processor if it has the edit mode and view mode of the system. A form processor can optionally contain the design mode.

It will be appreciated that the description herein uses PDF forms as an example due to its popularity and other advantages; however, the method from this invention is not limited to PDF format. It can be used for any suitable type of forms which provide an API for generating form images and manipulating the form data.

By choosing PDF as the basic format, the disclosed system is able to process PDF forms online directly. Processing a PDF form online as described herein means processing the form in a web browser, not in a PDF browser add-on. The form should look identical to the one in the PDF Reader or Writer. It is also meant that the user can get the same printout as from a PDF Reader/Writer. A goal is to minimize the cost and the need to keep paper copies of the e-forms, and to maximize the efficiency of forms processing.

### Component Features:

Both the template designer and form processor can be implemented as a client/server or a web system. Practically, a client/server implementation is preferred for the template designer because it is easier to implement, and has better performance. A web implementation is preferred for the form processor for all the advantages of the Internet and Intranet.

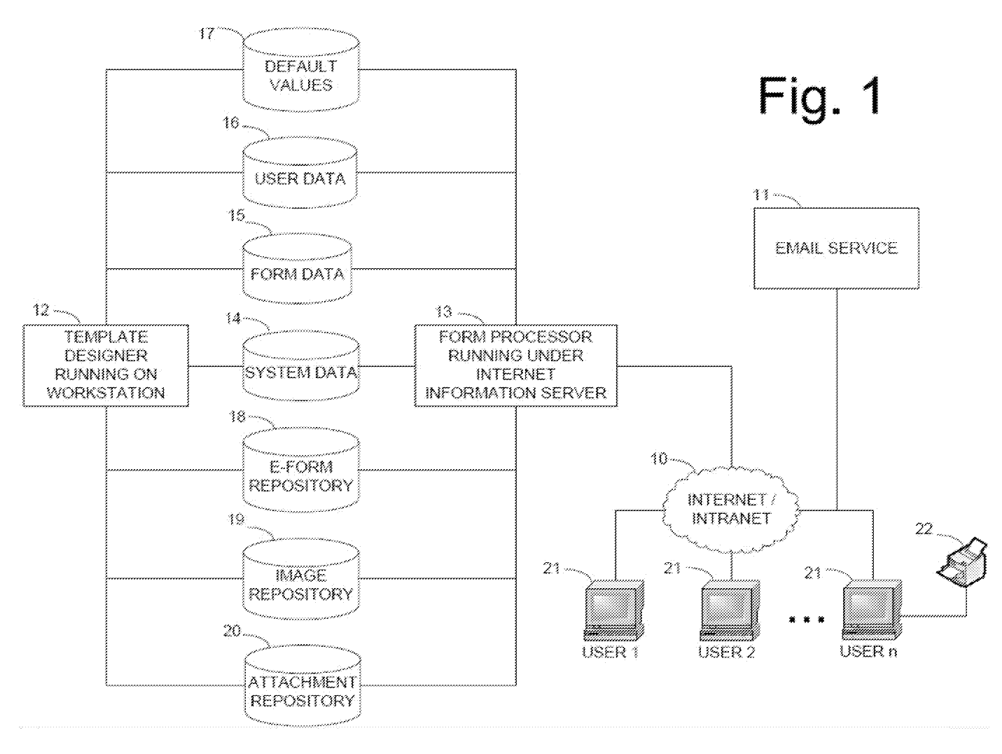

Referring to FIG. 1 there is shown a forms system incorporating features of the present invention. In FIG. 1, the template designer 12 is a client/server application. Form processor 13 is a web application running under any suitable internet information server. The end-user can process forms with a web browser on a client computer 21, which communicates with the form processor 13 through Internet/Intranet 10, and print forms on a local printer 22. The template designer 12 and the form processor 13 share the system data 14, the form data 15, the user data 16 and the default value data 17. The e-forms imported through the template designer are stored in the document repository 18. The images generated from the form documents are store in the image repository 19. The attachment files to forms from end users are stored in the attachment repository 20. Repositories 18, 19 and 20 are shared by the template designer 12 and the form processor 13. Email service 11 is used for workflow notification and sending other messages.

The system data 14 stores template information including input controls on the form, paths for files in the document, image and the attachment repositories, data connections, form tables, data-binding settings and data validation rules.

The form data 15 stores the input for forms from end-users, the user permissions and the processing status information of the workflow.

The user data 16 is required for authentication. It is also one of the main sources for default values because many forms require personal information.

The default value Data 17 represents data used for default values which are not in the user data. This data source is optional. Data 14 to 17 can be in a single database, or in different databases.

The system data 14 is generated with the template designer 12, and is used by the form processor 13. The Form Processor reads the system information from system data 14, loads the e-form and images from document repository 18 and image repository 19, displays the image as the background, and input controls on top of the image in the edit mode. It validates the input from the end-user through the controls, saves the information and process status in form data 15. The images in Image Repository are used by the template designer and the form processor as the background layer for form processing. The Original e-form in the Document Repository is used for image generation, form printing, saving e-form with user input data, accessing or searching e-form content.

Form Types

Except for HTML forms, electronic form formats are designed for client/server applications such as Adobe PDF Writer. It will be appreciated that in the prior art that it is difficult to use these type formats on the web directly. Although one can work on a PDF form within a browser with an Adobe reader or writer installed, it is the Adobe add-on, not the browser, which actually controls the form. The PDF files cannot really be processed on the web. Since the PDF or Word file formats cannot be processed by any browsers without installing add-on objects, the present inventions images the form as the background layer, and superimpose a data layer on top of the background. Instead of using scanned images as disclosed in the prior are, the present invention use images generated by the PDF SDK to insure exactly the same look as the original e-form. The PDF SDK is also used to fill a PDF form template for printing the form with Adobe reader or writer.

Display the Images of the Form

The HTML image tag (<img>) or client/server application image control is used to display the images of the form one page at a time. The input controls of the data layer are placed on the top of the image background. Navigation buttons or links are provided for switching pages in a form.

Controls for the WEB Implementation of the System

The present invention allows users to edit forms, to save data entered on forms to a database or e-form, to view and print forms with data. The data are entered and displayed through controls. The most typical controls are TextBox, ComboBox, CheckBox, RadioButton and Grid. However, it will be appreciated that any suitable control may be used. Unlike the standard controls such as the HTML controls for other systems, controls for the present invention change their look at run-time. In the design mode, the controls look like the regular controls for other systems. In the edit mode, a control may have a color background or a border if it is editable. It should be obvious that it is undesirable to print out a PDF form with controls such as ComboBox on it. For this reason, read-only control should have a transparent background. A read-only TextBox or ComboBox is displayed like a text string without borders or drop down arrow. A read-only CheckBox or a RadioButton in the view mode could be either a checkmark, or a blank. To distinguish controls used in this invention from ones for other systems, the prefix EF (standing for Easy Form) is added to the front of the control names. However, it will be appreciated that any suitable distinguishing prefix, or suffix, may be used.

Implement the Basic Dynamic Data Field Control (also known herein as Dual-look Control) for WEB Applications

Control Properties:

The controls for the web implementation of the form processor are implemented with the HTML input element. Some important control attributes and CSS (Cascading Style Sheet) properties used in this invention include ID, name, z-index, position, border, left, top, width, height, text-align, color, background-color, visibility, read-only, font-family, font-size, font-weight, value and checked.

The CSS position property is set to absolute for all controls and the position values are recalculated from the relative coordinate values saved in data 14 when the browser is resized. Each control has a unique “Z-Index” number which is greater the one for the form background image. This setting makes each control on a separate layer, and all the controls are in front of the background form image. Most properties are set in the design mode, and retrieved in the edit and view mode. In the edit mode, the controls are displayed at the same location, the same size, font, color and alignment as set in the design mode.

To implement the functionalities for this invention, additional properties, which are implemented with inline style sheet, are defined for controls:
PageNumber: Specifies the page number of the page the control is on. Controls with a page number different from the current page are not visible.
Level: Contains the access level number for the control set in the design mode. The control is read-only if this number is different from the current level.
Sub-Level: Contains the sub-level number. Only controls at Sub-Level 0 or at the current sub-level of the current level can be editable.
RoleID: ID of the role the control being assigned to.
DataType: This property is used for data validation. For example, the user cannot type letters for a numerical field.
MaxSize: This property is used to limit the maximum length or value of the input.
MinSize: The minimum length or value of input.
AllowNull: This property contains the “Allow Nulls” setting from the database for the field which is bound to the control.
Required: This property is true if the control was set to true in the design mode, or the property ‘AllowNull’ for the bound field in the database is to false. It is suggested to set ‘AllowNull’ to true in the data table for all fields bound to the form. If a field does not allow ‘Null’ or “Empty’, set the Required property to true. The reason is that the ‘Required’ property is checked only with the ‘Submit’ action, not the ‘Save’ action. This allows the user to save the form without all required fields completed.
Dependency: This property is for EFCheckBox and EFRadioButton only. If this property contains the name of a control, the control is visible only if the EFCheckBox or the EFRadioButton is checked. Otherwise, the control is hidden. This property gives the system the ability to handle conditional input.
FormulaIndexes: A form may contain some formulas for calculation. This property contains a list of indexes of the formulas containing this field.
Format: Contains a format string.

EFTextBox:

The EFTextBox for a single line of text is implemented with the HTML input tag with type=‘text’. The EFTextBox for multiple lines of text is implemented with the HTML tag TextArea. The EFTextBox may have a background color or border to indicate it is editable in the edit mode, and it appears like plain text in the view mode or when it is read-only.

An EFTextBox can be bound to a single database table field, or an expression containing one or more fields. In the later case, the EFTextBox is read-only. The content of TextBox can be a function of the contents of other EFTextBoxes. It will be understood that this provides a spreadsheet like functionality for calculation purposes. An EFTextBox can have a default value. This value can be entered in the design mode as a constant, or a query which retrieves a value from a database. This feature is different from default value property for the data field in a data table. The database default gives the same value all the time, while with a query, the default property retrieves a different value for a different condition, for example, a different user.

Unlike HTML TextArea, EFTextBox cannot have scroll-bars because the hidden text within a control with scroll-bars cannot be visible on the paper printout. For this reason, the present invention makes an EFTextBox extensible to another EFTextBox on a different page or an added page. These TextBoxes are bound to the same data field. The contents of these TextBoxes are separated by page breaker in the data field.

EFComboBox:

The EFComboBox control is implemented with a pair of HTML controls, a TextBox (type ‘text’ input tag) and a ComboBox (select tag). The two controls are the same size and placed at the same location with the select control in front of the TextBox containing the selected item. In the edit mode, the ComboBox is only visible after the TextBox is clicked, and becomes invisible again after an item is selected. In the view mode, the TextBox is not selectable and the ComboBox is not visible. The drop-down list of the ComboBox can be populated with items entered in the design mode, or with data from a database table or a XML file. The item selected by the user in the edit mode is copied to the TextBox control immediately.

EFCheckBox:

The EFCheckBox is implemented with an HTML image tag along with a set of images for checked and unchecked status in different modes. The image of the image control can be changed with JavaScript. The images used when the control is editable have background color or border. The images used when the control is read-only could be a check mark or ‘x’ without background color and border, or a transparent background with no image.

EFRadioButton:

The EFRadioButton is implemented with an HTML image tag along with the same set of images used for the EFCheckBox. The image of the image control can be changed with JavaScript. If it is editable, both checked and unchecked images should be visible so that the user knows the location of the control because not all the forms show squires to indicate the locations for checkmark. If it is not editable, the image may be a checkmark or ‘x’ for checked, and just blank for unchecked. An EFRadioButton must be in a group of more than one EFRadioButton. The EFRadioButtons in a group have the same value for the name attribute. EFRadioButtons can be grouped in the design mode. Only one EFRadioButton in a group can be checked at any time.

EFGrid:

The EFGrid is a collection of EFTextBox, EFComboBox and EFCheckBox with controls in a column being the same type. EFGrid has a transparent background so that the grid lines on the form image are not covered by adding EFGrid. The row height, column width and the space between any rows and columns are all adjustable so that the controls in EFGrid can fit into the cells of any grid on a form. To maximize the flexibility, each individual cell of the EFGrid can be resized independently, and can be placed anywhere on the form. The control types of the columns, the number of rows and number of columns can be configured in the design mode. Unlike grid controls in other programming tools such as GridView in ASP.NET, EFGrid cannot have scroll bars, which indicate some content are hidden. For this reason, an EFGrid are extensible to another EFGrid on the same page or on the next page and row mapping must be implemented for each EFGrid to the binding data table.

EFAnnotation:

The Annotation control is similar to EFTextBox. The difference is that it is available in the edit mode, not in the design mode. The user can place, move and resize the Annotation control on the form in the edit mode, and select font type, font size, color and other properties, and enter text to EFAnnotation control.

EFLink:

Is used to render HTML anchor element for adding links for navigation to other pages.

EFImage:

Is used to render HTML image control for adding image to the form.

Controls for the Windows Implementation of the System

The dual-look controls for this system can also be implemented for a client/server application. As shown in FIG. 1, the template designer of the current system was implemented as a client/server application. The advantage is that it is easier to implement for some features such as drag and drop, and has better performance. Instead of using inline style for WEB implementations, properties can be added to user controls directly for Winform applications. Following are brief descriptions for a few controls for a DOT.NET implementation.

EFTextBox:

The EFTextBox for this system is inherited from the Winforms EFTextBox. The appearance of the control can be easily changed by changing the control properties, such as BorderStyle, Location, BackColor, Size and Font. The background color and border is removed when the EFTextBox is read-only. Other properties are the same as the web version of the controls.

EFComboBox:

The EFComboBox for this system is a compound control with a read-only Label control superimposed by a Winforms ComboBox. The ComboBox is visible in the design mode. In the edit mode, it becomes visible when the label is clicked, and is hidden after an item is selected. The item selected by the user in the edit mode is copied to the label control immediately. The items in the drop down list can be populated the same way as the WEB implementation.

EFCheckBox and EFRadioButton:

These two controls are implemented similar to the web version except the Winform PictureBox control is used for the checkmark or blank image.

Template Designer

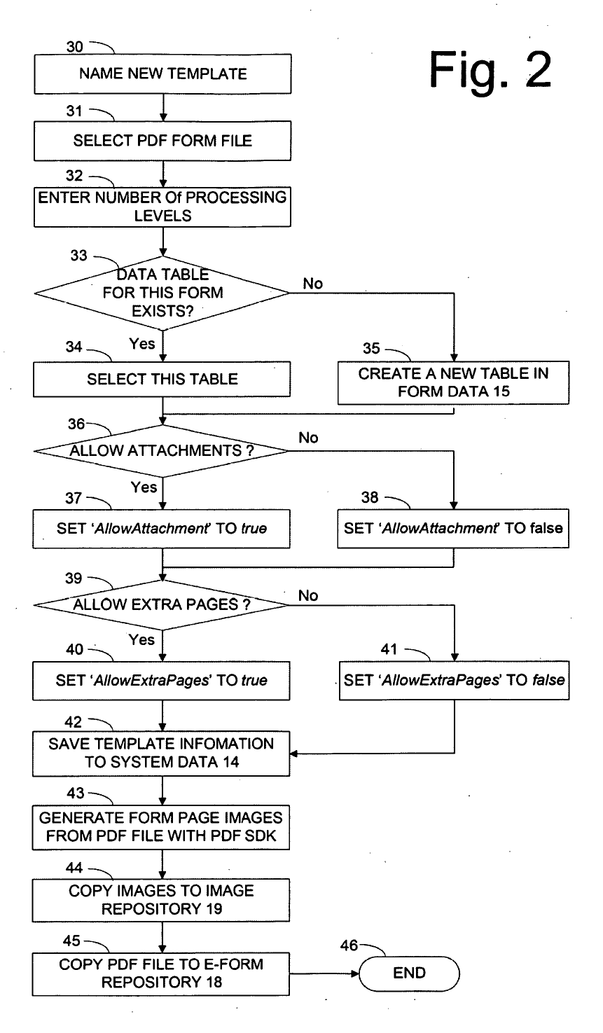

FIG. 2 shows the workflow for creating a new template. If a form is not a PDF file, convert to a PDF file before starting the process. A template name is entered at block 30. A PDF form is selected for the new template at 31. Number of levels is given at block 32. Level is defined as the processing order of non-overlapping sets of input on a form. Level 0 is also called the Form Preparation level. Other levels are collectively called Admin Levels. Most forms have two levels: the form preparation level and one Admin level. Block 33 tests whether or not there is a data table or updatable view for this form. If there is one, select this table at 34, otherwise, create a new table or updatable view for this form at 35. Blocks 37 and 38 set the variable ‘AllowAttachment’ to true or false based on the answer at block 36. Some forms allow the user to add extra pages if the existing pages are not enough for the content to enter. If this is true at block 39, set the variable ‘AllowExtraPages’ to true at 40, otherwise, set it to false at 41. The template information is saved to the system data 14 at block 42. The form images are generated with PDF SDK at block 43 and saved in the image repository 19 at block 44. It is possible to generate the images on the WEB server when the images are needed, however, it would slow down the web site and server license is required for the PDF SDK. The PDF file is copied to the document repository 18 at block 45. The process ends at block 46.

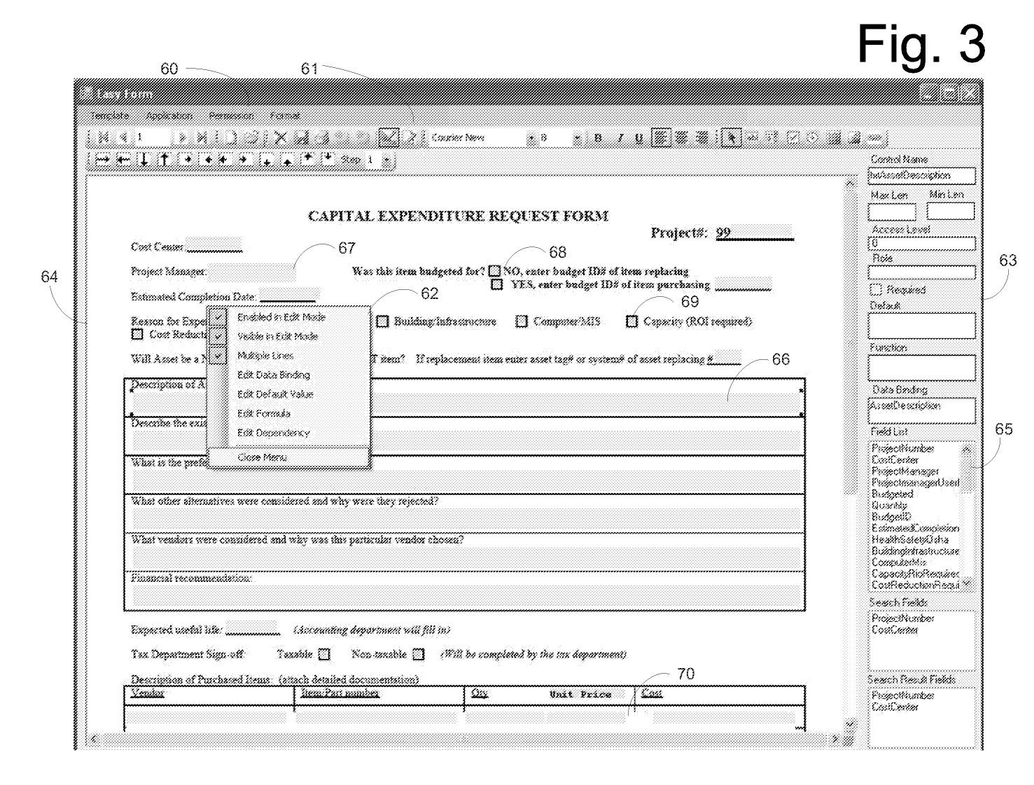

FIG. 3 shows the main window of the Template Designer 12 with the menu 60 on the top, toolbars 61 below the menu, the property panel 63 on the bottom-right, and the client area 64 for template editing on the bottom-left. The example PDF form for the template is displayed at 64 with a EFTextBox 66 selected and the context menu 62 is displayed for 66. Other control types on the form are EFComboBox 67, EFRadioButtons 68 which are in group and only one of them can be checked at anytime, EFCheckBox 69 and EFGrid 70. Only the first row of 70 is visible in FIG. 3. Item 65 is the list of fields which can be selected to bind to a control in 64.

The template designer is used to perform the following tasks:

### Add/Remote Controls

Controls can be added to the template by dragging any control icons in the control toolbar to the target location on the form. Controls on the form can be resized and moved by the mouse or the arrows in the toolbar. With a form image as the background, it is easy to place the controls at the desired location.

A control can be deleted by selecting the control then pressing the delete key.
Set control common properties: The properties common to all controls include:
Name: A default name is given when a control is placed on the template. The default name can be changed, but must be unique for each template.
Access Level: The input controls can be grouped into multiple processing sections based on workflow or access levels. Controls in each section are assigned to a section number. The default number is 0. Levels greater than 0 are considered as Admin Levels. In the edit mode, only controls at the processing level are editable. Controls in other sections are read-only.
Role: A control can be optionally assigned a role, which is defined as exclusive permission for processing a non-overlapping (or exclusive) subset of controls within a level.
Sub-Level: A level may contain I or more sub-levels. A sub-level may contain 0 or more roles. Roles within a sub-level can be processed parallel. Sub-level 0 for each level does not contain any roles. Sub-level greater than 0 must contain at least one role.
Required: If an input for a control is required, the user must enter a value before submitting or passing the form to the next sub-level. Role and sub-level will be discussed in details later. A good practice is to set the “AllowNulls” property to true in database table for all but the ID field because you cannot save a form before completing all fields not allowing nulls. Making fields required but allowing nulls in the database enables users to save the form at any time.
Default Value: A control can have a default value. The default value can be a constant such as an integer or a string, or a query. Many forms require personal information, which can be retrieved from a user or employee table. The default value property can significantly reduce the amount of work for filling forms. Unlike the database field default, this property allows the retrieval of default values for multiple users at different stages of the form workflow.
Data-binding: A control can be bound to a field or an expression containing one or more fields from a database table or view. If a control is bound to an expression, it will be read-only. Unlike other controls which bind to a single table field, the EFGrid binds to a data table with the ID field of the form as a foreign key.
ReadOnly: A control cannot be edited in the edit mode if this property is set to true.
Visible: A control is not visible in the edit mode and the view mode if this property is false. This property is false if the control is not on the current page.
Dependency: The value of this property contains the name of an EFCheckBox or an EFRadioButton. The control with dependency is visible and required only if the EFCheckBox or the EFRadioButton in the property is checked. This property adds power to the system for handling complicated forms.

Properties for EFTextBox and EFComboBox

EFTextBox and EFComboBox have Text property, and thus, Font Family, Font Size, Font Style and Text Alignment can be set in the design mode.

Properties only for EFTextBox
Multiple Lines: The control can show multiple lines of text if the property is set to true.
Function: This property is similar to the spreadsheet function. The content of an EFTextBox can be a function of contents of one or more other controls. This property gives this system the spreadsheet like functionality for calculation.
Format: This property is used to format the Text property.

Populate the Items of the EFComboBox

The items of an EFComboBox can be populated by entering a list of items directly, or by assigning a query in the design mode. Validation is performed to insure that the items in the drop-down list are compatible with binding field for the ComboBox.

Fill Controls with Default Values

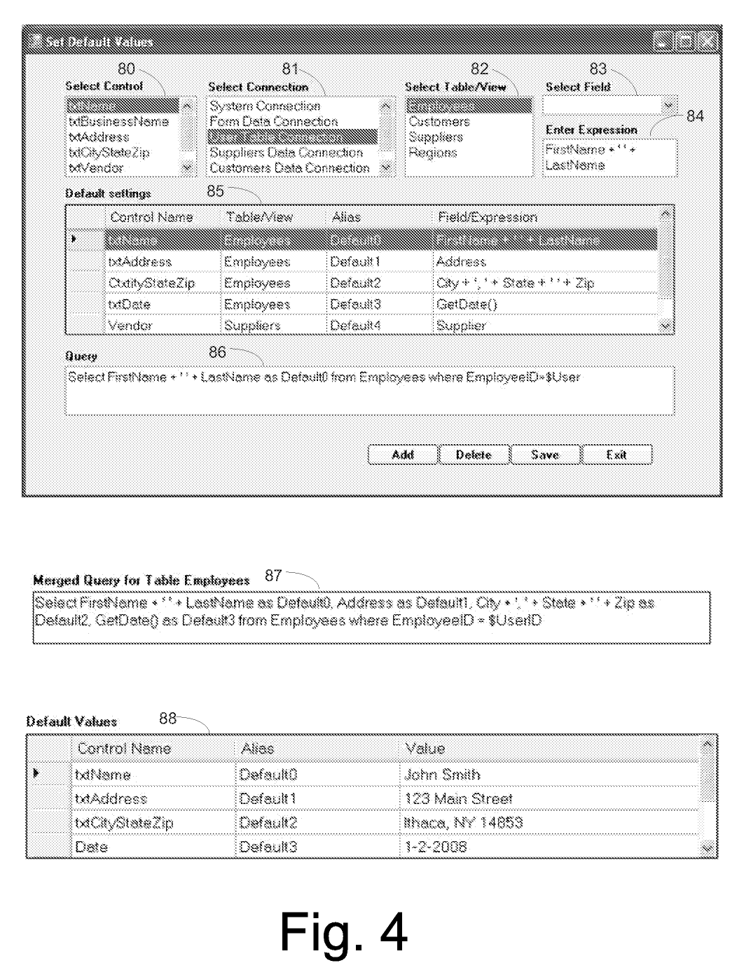

FIG. 4 shows the method this system uses to retrieve default values for controls. This method allows retrieving default values from multiple data sources for multiple users at different stages of the form workflow. In FIG. 4, the user selects a control in list 80, selects a database connection from list 81, selects a data table or views in list 82. For the selected table or view, the control can either get default value from a single field selected at 83, or from an expression entered at 84, which shows the full name from the field ‘FirstName’ and ‘LastName’ separated by a space. Each field or expression is given an ‘Alias’. Grid 85, which is sorted by the ‘Table/View’ column, contains the default settings for five controls. The first row is for the selected control in 80, selected database connection in 81, selected table in 82 and the expression in 84. The query for retrieving the default value in row 1 is show in 86. In this query, $UserID will be replaced at run-time by the User ID of the user.

If multiple rows in grid 85 share the same data table or view, “Employees” for the top four rows in this case, the queries will be merged as the one shown at 87. This approach dramatically reduces the number of queries.

Grid 88 shows the retrieved default values for the top four rows in grid 85.

Save Template

Changes for the template can be saved at any time in the design mode by clicking the save button. It is important to save the coordinate as the percentage of the image height and width.

Assign Permissions to Forms

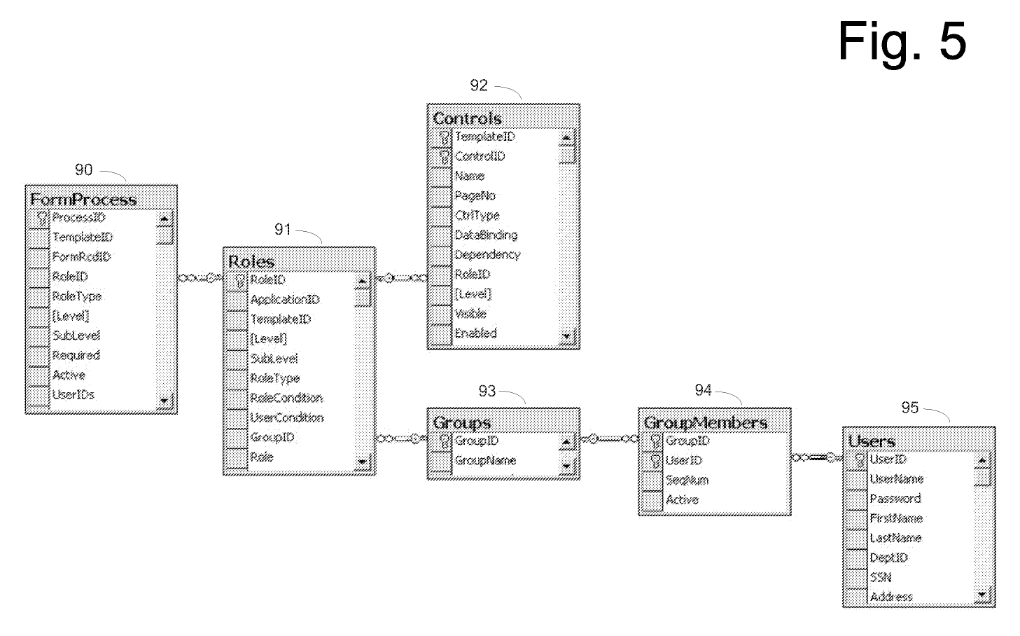

FIG. 5 shows the structures and relations of die tables related to permission for forms. The template designer provides a user interface to create groups which are saved in the group table 93. A group contains 1 or more group members in the group members table 94. The group members are stored in the users table 95. Each group member is assigned a sequence number ‘SeqNum’ with lower value standing for higher priority. Multiple group members can have die same sequence number. A group member can be either active or inactive. Only active members with the lowest sequence number and meet the condition in ‘UserCondition’ in table Roles 91 get the permission for performing the task of the role. Other members are spared or substitute members. As we mentioned before, a role (in table 91) is defined as exclusive permission for processing a non-overlapping subset of input within a sub-level for this system.

There are four type roles:
Main Role: Main role has the following privileges: 1. Assign user to level 0 support roles; 2. Access level 0 any time before the form is submitted to level 1; 3. Submit form to level 1. There could be more than one main role, for example, forms for joint account. The first main role is automatically assigned to the form initiator, who then assigns other main roles if there are any.
Approval Role: Approval Role has the permission to approve the form solely or with other approval roles. Approval roles are for Admin levels only.
Support Role: Roles other than Main Role and Approval roles are support roles. A support role can be at any level. Support roles for Admin levels are assigned by the system administrator, and are responsible to all form instances of die form. Support roles for level 0 are assigned by the initiator of the form instance, and are only responsible to the form instance.
View Role: This role has the permission to view completed or uncompleted form in the view mode based on the setting for the template. Multiple users with view permission can share the form simultaneously.

A control in table Controls 80 of FIG. 4 has a default level number 0. If it belongs to a section to be processed at an Admin level, it is assigned a level number greater than 0. Before a control is assigned to a role, it has a sub-level number 0. In other words, sub-level 0 is for controls not assigned to a role. A role must be assigned a positive sub-level number. On the other hand, a sub-level with a positive number must contain at least one role. Sub-levels containing roles within a level are processed in ascending order except for the main role. Roles within a sub-level are processed parallel or in any order. Section for a role can only be process by users with permission for the role. Section for sub-level 0 can be processed by any user with permission for the level.

A person starting a new form automatically gains main role permission. He also has the privilege to grant permission to users for support roles for level 0, and to submit the form to level 1. Roles for Admin levels are granted to groups by the system administrator. A group contains 1 or more group members. Permission for the form preparation level is for a single form ‘instance’, while permission for Admin level roles are for all the form instances of the same form. To distinguish the two types of permissions, we call the former permission for ‘form instance’, and the later, permission for ‘form’.

To access a form instance in edit mode, a form process object is created and stored in table FormProcess 90 for each role. The for process object contain all information for the corresponding role, plus the status of the process and some other information. Two properties are important for implementing dynamic workflow: Required and Active. These two properties are set to true by default. A form process must be active to allow users with permission for the role to access the form instance. Required is determined by ‘RoleCondition’ in table Roles 91. If ‘RoleCondition’, which is a query or a stored procedure, returns false, Required and Active are set to false. After the form process is created, the changes made by other roles may change ‘RoleCondition’ to false, and there forth, change Required and Active to false. Another case to change Active property to false is when the user completes the section for the role.

Level, sub-level and role form a three-dimensional space, which can be represented as follows:
Let Lᵢ be the ith Level,
Sᵢⱼ be the jth Sub-Level within the ith Level and
Rᵢⱼₖ be the kth Role within the jth sub-Level and ith Level,
where i=0, 1, . . . , m,
j=0, 1, . . . , n(i) and
k=0, 1, . . . , p(ij).

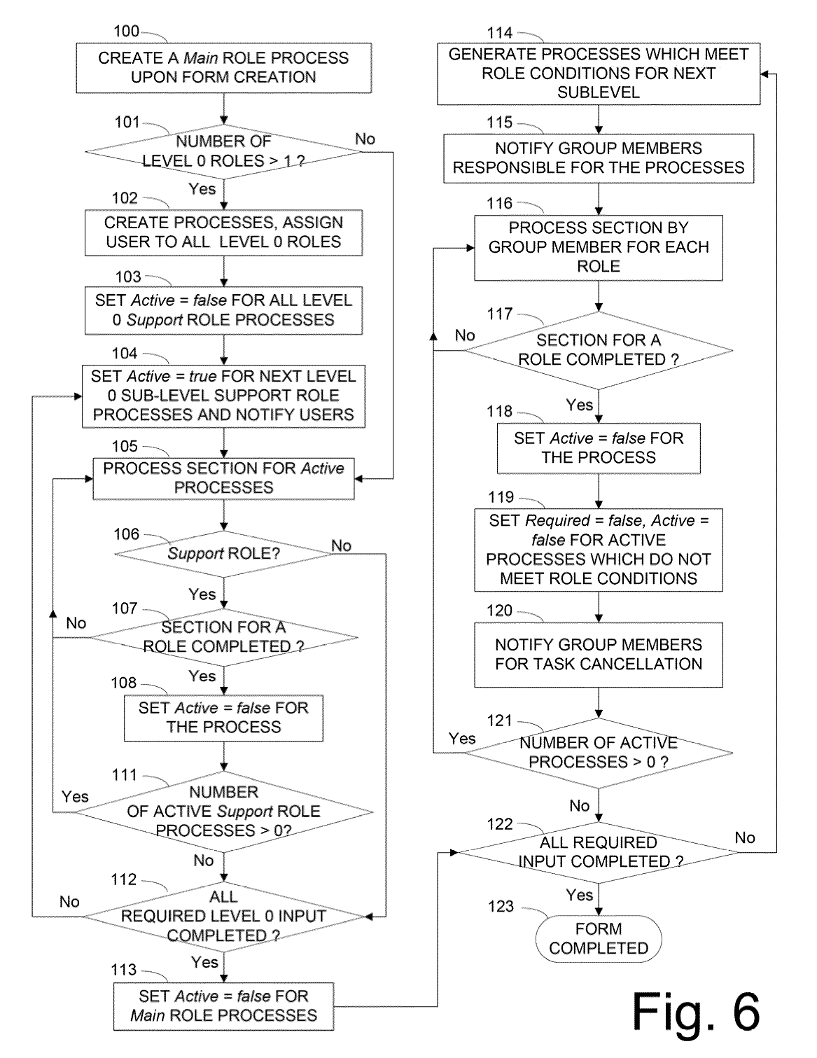

FIG. 6 shows the dynamic workflow implemented with Levels, Sub-Levels and Roles. For a form instance, each role is assigned a form process and one form process belongs to one role. For this reason, we use role and process alternately for workflow. The left panel is for level 0 or the form preparation level. The right panel is for the admin levels. Upon a new form instance is started at block 100, a process for the main role is created for the form initiator. As we have mentioned, the two properties Active and Required are set to true by default. If level 0 has more than 1 role (101), generate processes for all other roles and assign users to these processes at 102. These processes could be for additional main roles, for example, for a joint account, or for support roles. The processes for support roles are deactivated by setting the Active property to false at 103. The workflow model for this system process sub-levels sequentially, and the roles within a sub-level parallel. Thus, at any time, only roles in one sub-level are active except for main roles. At block 104, if there are un-processed sub-levels, the processes for the next sub-level of level 0 are set to Active, and the assigned users are notified by email or other ways. These active roles are processed parallel at block 105. Block 107 checks the section for a support role is completed or not. If it is not completed, loop back to block 105, otherwise, set property Active to false at 108 to deactivate the process. Blocks 105 to 112 are executed repeatedly until all processes for support roles in the current sub-level deactivated. Since the main roles remains active at level 0, the workflow bypasses block 107 to 111 for main roles. Blocks 104 to 112 are execute repeatedly until all required input for level 0 are completed. Block 113 deactivates main roles and move to the test at block 122.

Block 122 tests whether or not there are uncompleted sub-levels. The form is completed at block 123 if there is no more uncompleted required input. Otherwise, block 114 generates processes for the next sub-level which contains roles with positive role condition. The role condition is a ‘filter’ for the corresponding role. For example, assume an IT manage needs to sign all IT related purchase orders. If the role condition is “Is an IT order” returns false, the signature from an IT manager is not required and the role for IT manager should not be in the workflow. The corresponding group members are notified at block 115. A responsible member meets the following three conditions. 1. The property Active is true; 2. Having the lowest sequence number among the active members; 3. Satisfying the user condition. The first two conditions allow a group member to have substitute for his duty. When a group member for a role is not available, for example, on vacation, he can set the Active property to false, in this case, another active group member with higher sequence number will automatically take over the responsibility. The user condition allows directing the task for the role to the right group member. For example, a group for a Department Manager role may contain all department managers for a company. Assuming this role is responsible to sign the purchase orders of his own department, the role condition would be “the manager of the form initiator's department’. Combining the role condition and the user condition, this system directs the form instances to the right role and right group members. Block 116 and 117 are executed repeatedly until the section to be processed for a role is completed. Block 118 then set the process property to false. The changes of the form content at 116 may affect the role conditions of other unprocessed active processes. At block 119, set the properties Required and Active to false if the role condition for an active process is no longer true. Assume a company has the rule: “A purchase order with the amount between $25,000 and $50,000 requires either CEO or CFO to sign, not both”. In this case, after a purchase order is signed by one of the roles of CEO or CFO, the process for the other role should be deactivated. When a role is deactivated in block 120, the corresponding group member is notified for task cancellation. Block 119 and 120 could also be placed between block 108 and 111 for level 0. However, it is rarely necessary for level 0 to have this logic. Block 121 test whether or not there are still active processes, if it is true, repeat blocks from 116 to 120. Otherwise, test the form complicity. If it is not completed, repeat blocks 114 to 121 until all required input are completed. The workflow ends at 123.

For clarity, FIG. 6 did not show the path for return or rejection. This system allows a user to return the form instance to a previous sub-level or a previous level. When a form instance is returned, a message is sent to related roles to explain the reasons for return or rejection.

This highly flexible model allows handling any form workflow in a hybrid sequential and parallel way.

Create Application

The template designer provides user interface to group more than one form as a package or application. An application, which some commercial products call a package, cannot be submitted or passed to the next level unless all the forms in the application are completed. Application has advantages for managing multiple forms.

The WEB Implementation of the Form Processor

WEB Integration

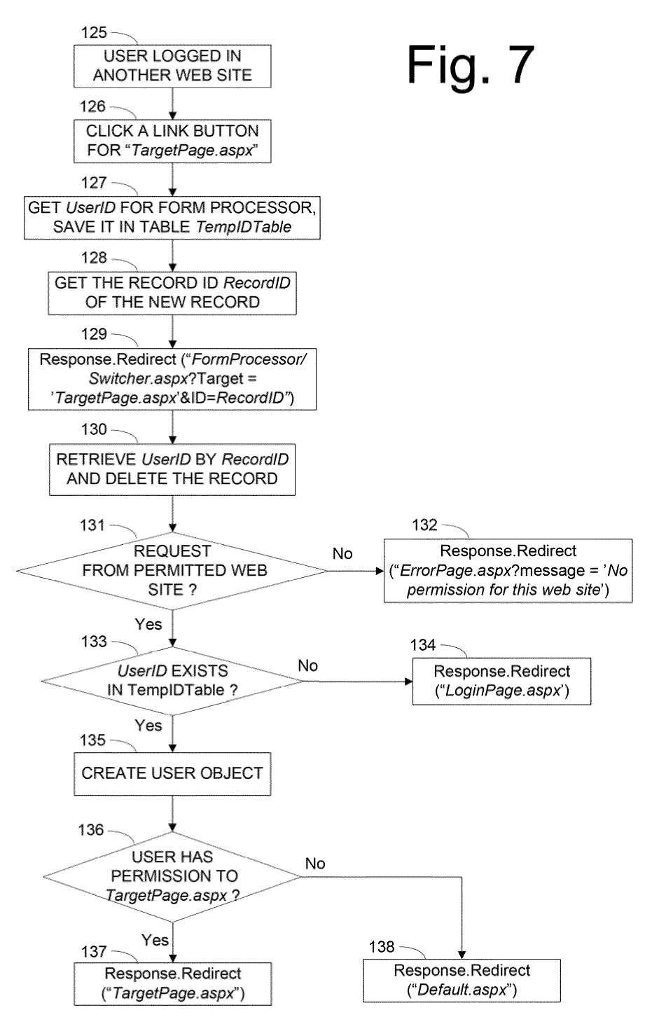

The form processor 13 in FIG. 1 is a web application; the form processor may be integrated with other web sites. The form processor requires authentication for retrieving user permission for forms or applications to work on. The user can login the form processor directly, or login a different web site, then redirect to the form processor. To avoid logon multiple times, the system implemented a simple but secure single sign-on feature. FIG. 7 shows the workflow for the single sign-on feature. ASP.Net notations were used in the flowchart, but it should be easy to implement with any other languages such as JSP or PHP.

To be able to pass user id, which may not be the same as the one the user used to login, to the form processor, web application need a data connection to user data 16 in FIG. 1. User data contains a database table which may call TempIDTable. This table contains a numerical key field RecordID and a UserID field for storing the user id for the form processor. FIG. 7 starts at block 125 where the user logged in a web site from where the form processor can be redirected. At block 126, the user clicked a link for a web page “TargetPage.aspx” (the name can be replaced with a real page name) of the form processor. The user's user id for the form processor is retrieved and then inserted into TempIDTable at 127 and the record id for the new record for the UserID is returned at 128. It is then redirected to an entry page “Switcher.aspx” of the form processor with two parameters: the target page name and the record id at 129. Upon receives the request at 130, Switcher.aspx retrieves the user's UserID by the record id, and then delete the record immediately. The form processor keeps a list of web sites allowing redirecting to the form processor. If the request was from a web site not in the list, the request is redirected to an error page with the message “No permission for this web site” at 132. Otherwise, the UserID is validated at 133. For an invalid UserID, the request is redirect to the login page for the form process at 134. For a valid UserID, a user object is created at 135. Based on the test whether or not the user has permission the requested target page at 136, the request is either directed to the target page at 137, or the form processor default page at 138 for creating new form instance.

It will be appreciated that the UserID for the form process is inserted into TempIDTable and the record id is retrieved. It will be understood that this approach is very secure because it is processed on the server-side. For an enterprise web system, everything is done behind the firewall. The record id is not visible for external users. The record for the UserID exists in table TempIDTable for a very short period of time (between block 126 and 130). In most cases, it should be much less than a second. It is almost impossible for an intruder to get and use the information.

WEB Page for Processing Forms

The page contains the following components:

Toolbar: The toolbar contains the following buttons or links:
Navigation: for switching to the first page, the last page, the previous page, next page or a specified page.
Save: for saving the input to the page in the edit mode.
Submit: for passing the form to the next sub-level after a sub-level is completed or mark the form completed if the form is completed. Edit mode only.
Return: for returning the form to a previous level or sub-level. Admin levels only.
Print: for getting paper copy of the form and saving the e-form with data.
Attachment: for uploading attachment documents at level 0. This is available if the “Allow Attachment” setting is true for the template.
Attachment ComboBox: is visible if there exists at least one attachment for the form instance.
Annotation: For adding annotation to a page.
Add Page: for adding additional pages if the current pages are not enough for input.
Assistance: For the main role to assign users to level 0 support roles, or to delegate authority to other users for main role.
Links for the home page and other pages.

Server-Side Script:

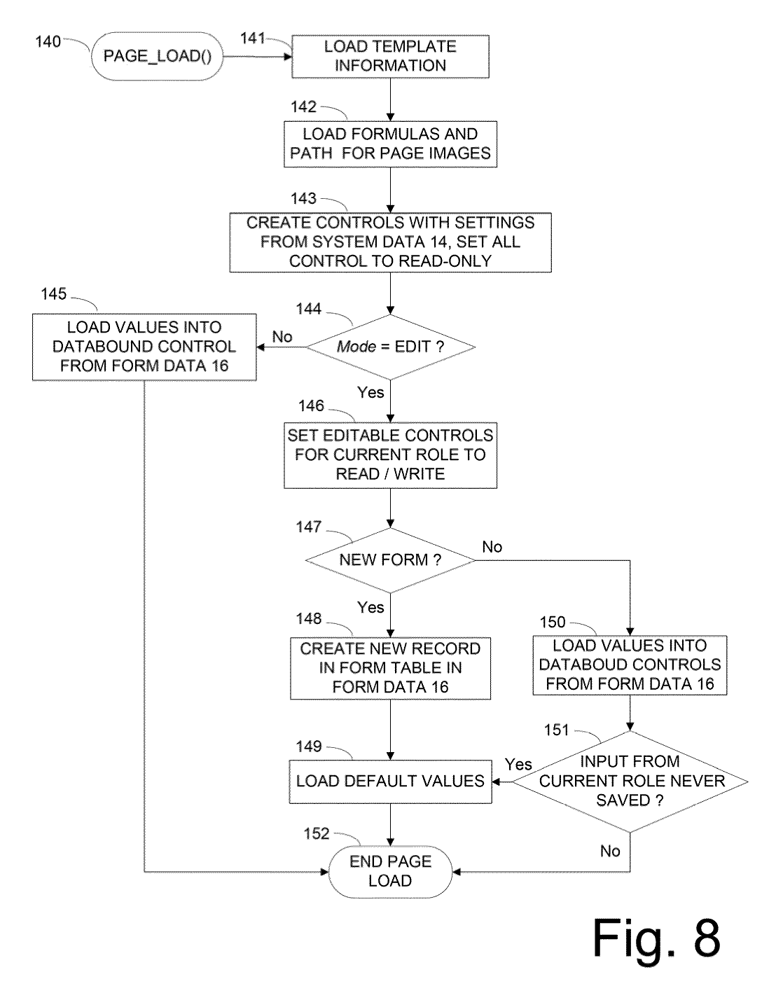

The server-side script for this page is for rendering the HTML page for processing PDF form. FIG. 8 shows the process for loading the HTML page. The process starts at the Page_Load( ) event at block 140. The template information from system data 14 in FIG. 1 is loaded at block 141. Template information includes the PDF file name and path, the page image paths, the form table name, the number of access levels and whether or not allowing attachments. Formulas, if there are any, are loaded into a JavaScript string array at block 142. At block 143, the dual-look HTML controls are created with settings from system data 14. All controls at set to read-only at this stage. Block 144 detects the mode. For the view mode, the values of the controls are loaded from form data 16, and the Page_Load event ends at block 152. For the edit mode, the editable controls are set to read/write at 146. Editable control here includes the control assigned to the current role, and sometimes, controls not assigned to any roles (sub-level 0) for the current level. These controls are editable before the Active property for the process is changed to false. If the form instance is new (block 147), a new record is created in the form data table 148. Block 149 loads default values. The default values are loaded into controls before the fields for the current role are saved the first time. For a new form instance, load default values into controls for sub-level 0 of level 0 and for the default main role. For an existing form instance, the control values are loaded from form data 15 at block 150. If the input from the current role has never been saved (151), default values are loaded at 149. The test at 151 insures that the values the user changed are not replaced by default values. After block 152, the HTML page is sent to the client's computer.

Client-Side JavaScript:

The browser on the client computer 21 in FIG. 1 sends request to the form processor 13 through the Internet or Intranet. Upon receiving the requested page, the browser runs the JavaScript initialization, and then displays the page. Thereafter, it waits events and executes the corresponding JavaScript functions for the events.

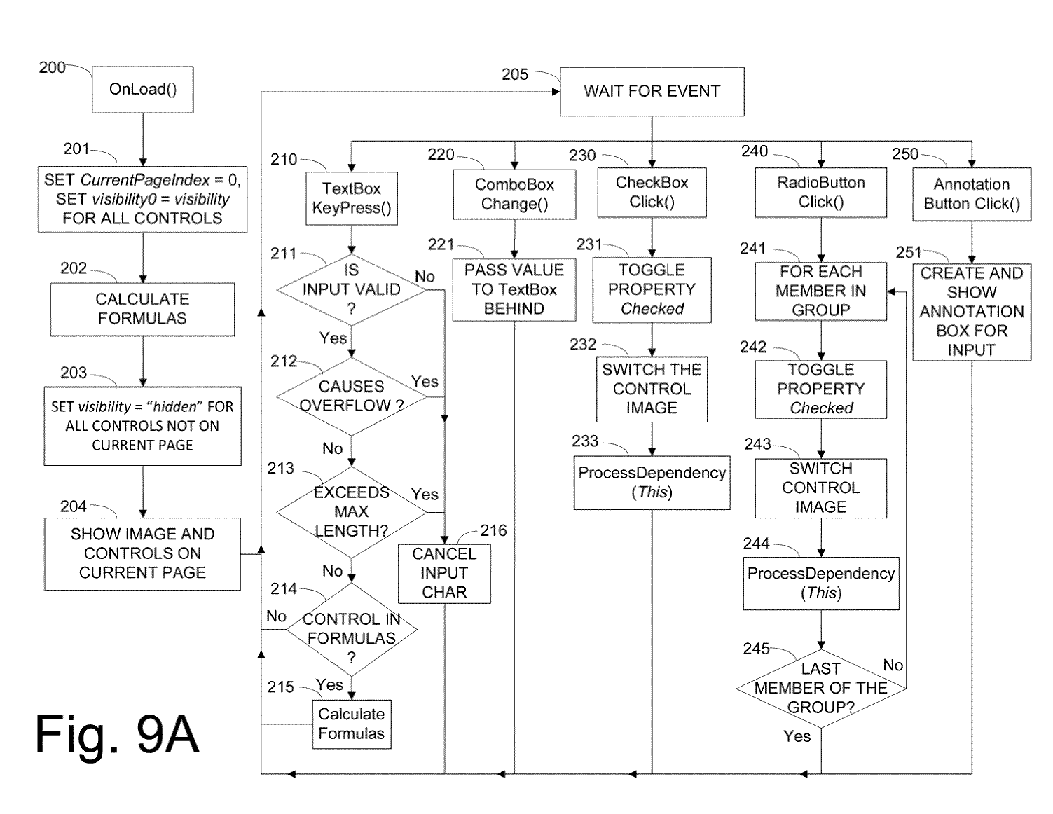

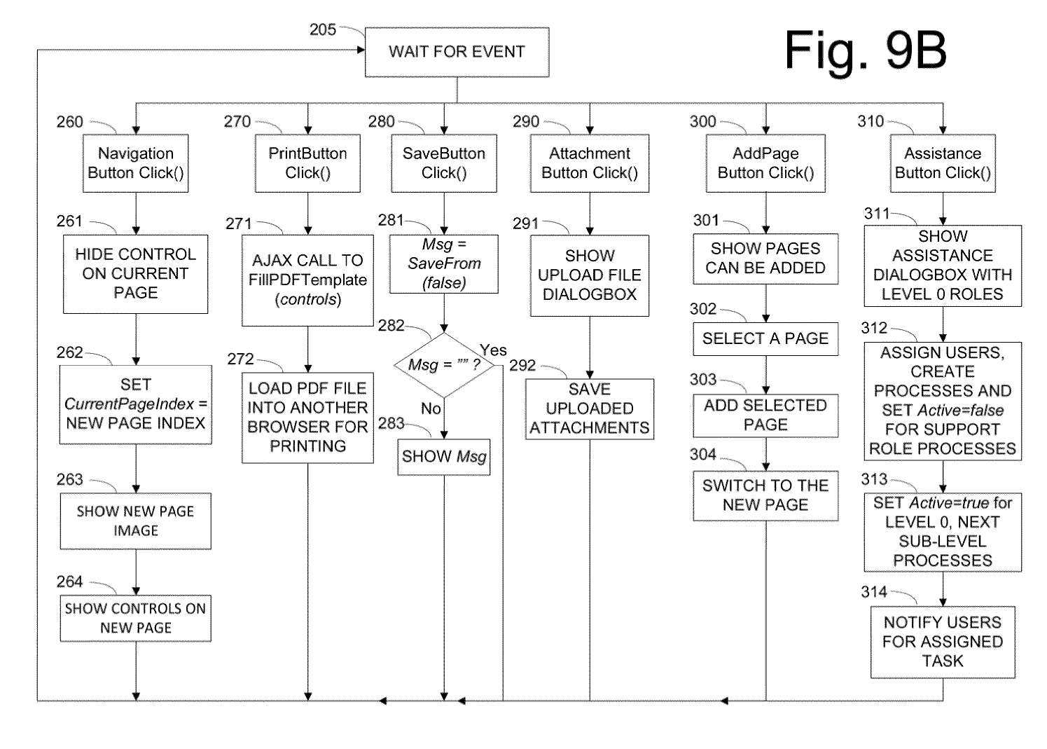

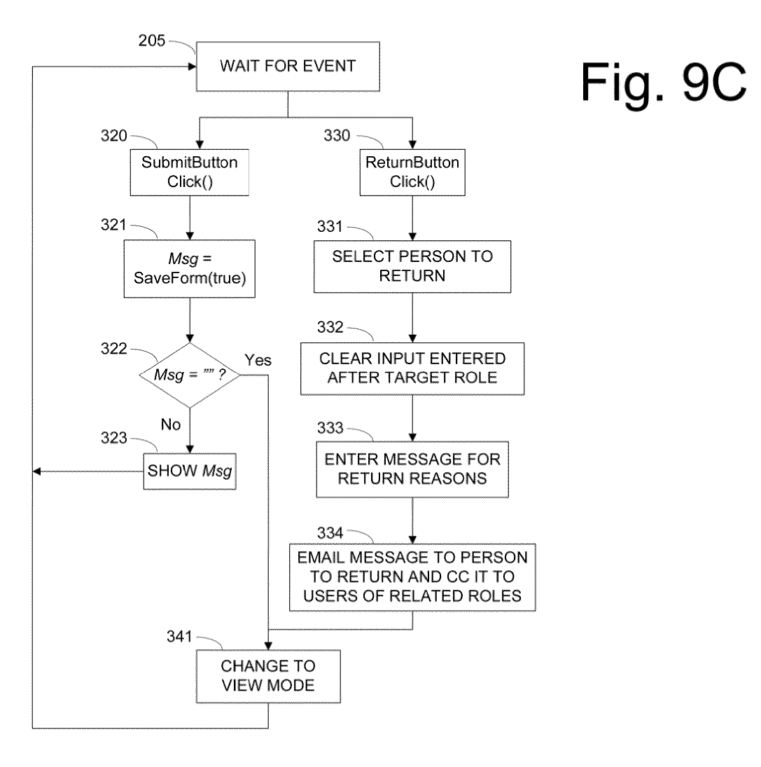

FIG. 9A-9C show the JavaScript events diagram for the form processor. The initialization process before displaying the first page starts with the OnLoad event at block 200. At block 201, the variable CurrentPageIndex is set to point to the first page (page 0) and the attribute “visibility” is saved in “visibility0” for all controls. “visibility0” keeps the original value of “visibility”. If there are any formulas in the template, the formulas are calculated and the values of the controls with a formula are updated at block 202. At block 203, the property “visibility” is set to “hidden” for all controls which are not on the current page. This leaves only the controls on the current page visible. The page is displayed at block 204 after initialization and waiting for events being triggered at block 205.

FIG. 9A-9C show the main events for the form processor:

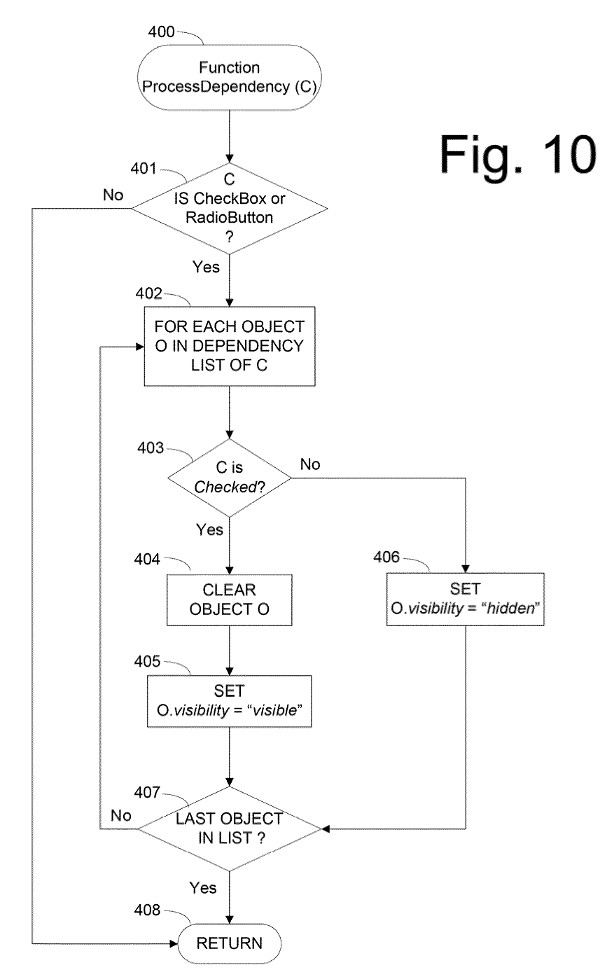

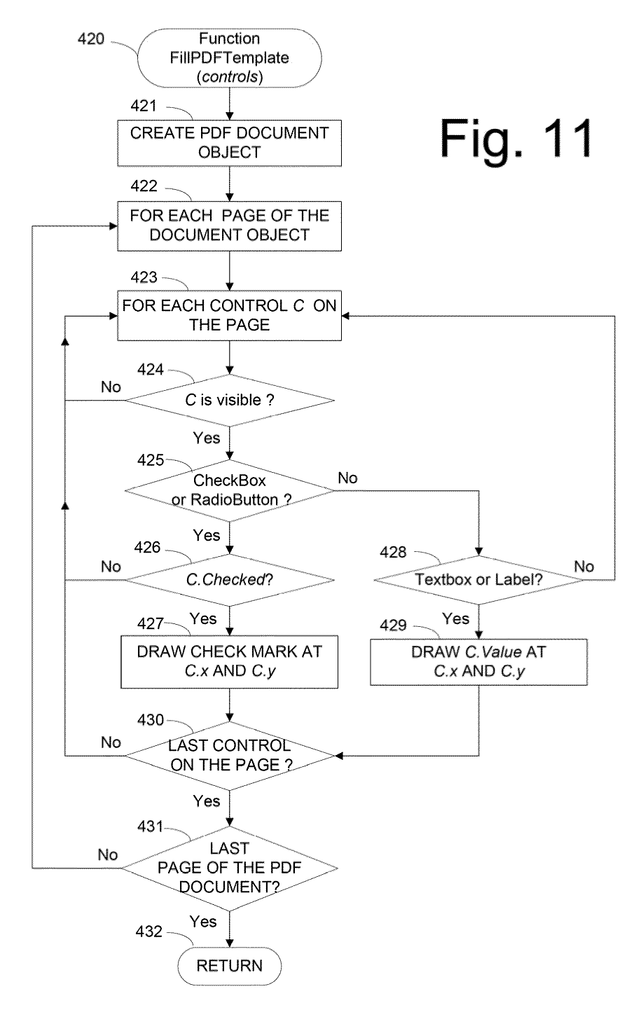

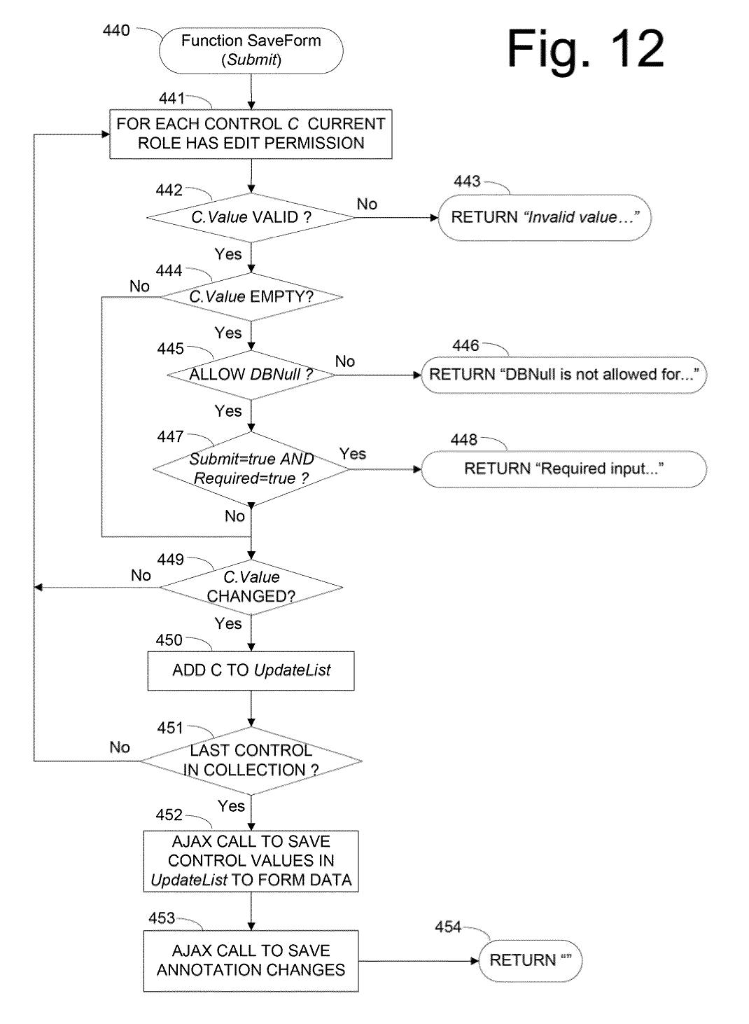

TextBox_KeyPress( ) at block 210: This event is triggered when a key is pressed. The system allows defining a set of invalid characters for the form. Block 211 tests whether or not the input character is valid. The input character is invalid if any of the following conditions is true:
The character is in the predefined invalid character set.
The character is not compatible with the input type for the control. For example, a letter is not valid for a numerical field.
The character is valid, but it makes the current content invalid. For example, the input is a period while the value of the control already has a decimal point.
   If the input is invalid for the test at 211, or causes overflow at 212 or exceeds the maximum string length at 213, the input is cancelled at block 216, then go back to block 205 waiting for new events. Otherwise, if the control is in any formulas (block 214), the formulas are calculated and the value of controls having a formula is updated at 215, then go back to 205 waiting for new events.
ComboBox_Change( ) at block 220: This event is triggered when a different item was selected. When this happens, the text of the EFComboBox is copied to the TextBox behind the ComboBox and the ComboBox is set to invisible.
CheckBox_Click( ) at block 230: This event is triggered when the EFCheckBox is clicked in the edit mode. In this event, the value of the property “Checked” is toggled at block 231; the image is switched to the checkmark image or the blank image at block 232. The last thing for this event is calling a function ProcessDependency( ) in FIG. 10. The control is passed to the function as a parameter. In FIG. 10, the function starts at block 400. Block 401 tests the control type. If the control is not a CheckBox or a RadioButton, exit the function at block 408. The function does nothing if no other objects depend on the passed control. Object here can be a single control, a page or a form in a form group or application. If there is a list of objects the visibility of them depend on the passed control's property Checked, then for each object O in the dependency list, go through the process between block 402 and 407. If C is checked, clear the value of the controls of the object and make object visible. Otherwise, hide the object at block 406.
RadioButton_Click( ) at block 240: This event is triggered when an RadioButton is clicked. Because clicking an EFRadioButton affect all members in its group, between block 241 and 245, the same procedure for EFCheckBox is going through for each member of the EFRadioButton group.
AnnotationButton_Click( ) at block 250: When this event is triggered, an annotation control is created and displayed on the form. The user can move or resize the control, or enter an annotation and at 251. The input to die annotation will be saved when the save button is clicked.
NavigationButton_Click( ) at block 260: When this event is triggered, the controls on the current page are changed to invisible by setting the visibility attribute to “hidden” at 261. The index of the target page for the button, which is one of the four buttons for the first page, the previous page, the next page and the last page, is assigned to the variable CurrentPageIndex at block 262. The new page image is displayed at 263, and the visibility attribute of the controls on the new page is restored from visibility( ) at block 264.
Print Button Click( ) at block 270: The easiest way to handle printing PDF files is using the PDF SDK to draw the input values in an empty PDF form, then open the filled form with a PDF Reader for printing. When the Print button is clicked, an AJAX call is made to a server-side function FillPDFTemplate. The input control collection is passed to the function as a parameter. The function is shown in FIG. 11. It starts at block 420 and a PDF document object is created at block 421. For each page of the PDF document (422) and each control c in the control collection on the page (423), blocks between 424 and 430 are executed repeatedly. If the control is visible (424), a boolean value true of a control is drawn as a checkmark, a string value of a control is drawn as a string at the control's location (C.x, C.y). The function ends at block 432. The newly filled PDF form is loaded into another browser window for printing and saving the PDF form with data at 272, then return to block 205 waiting for new event.
SaveButton_Click( ) at block 280: When this event is triggered, the function SaveForm( ) in FIG. 12 is called at block 281 with “false” as parameter value. The return value is assigned to a variable “msg” for error message. If “msg” is not empty (282), display the message at 283, then go back to block 205 waiting for event. The function “SaveForm” starts at block 440 in FIG. 12 with a Boolean type parameter “Submit”. This parameter is true if the user clicked a button for submitting the form or passing it to the next sub-level, and is false for just saving die changes. Blocks from 441 to 451 are executed repeatedly for each control which can be edited by the current role. If the control value is not valid at 442, the function returns a message for invalid control value at 443. If the control value is not empty (444) and the control value was changed (449), then put the control in a list “UpdateList” at 450, otherwise, skip the control and go back to 441 for the next control. If the control value is empty (or null) at 444, and die binding database field does not allow null (445), return an error message for not allowing null in 446. If the parameter “Submit” is true and the control input is required at 447, then return an error message for the required input at 448. When the loop is completed without errors at 452, an AJAX call is made to save the change of the controls in the list “UpdatedList”. The annotation changes, if there are any, are saved at 453 by an AJAX call. The function ends at 454 and an empty string is returned to the caller.
AttachmentButton_Click( ) at block 290: When this event is triggered, an upload file dialog box is displayed for selecting attachment files at block 291. The selected files are uploaded and saved to the attachment repository 20 in FIG. 1 at block 292, then go back to block 205 for new events. This button is visible if the option “Allow Attachment” was checked for the template.
AddPageButton_Click( ) at block 300: Sometime an form is not enough for the content to be filled. For example, the number of records is greater than the number of rows in a grid. In this case, additional pages with grid showing the same columns need to be added. This button is visible if the option “Allow Adding Page” was checked for the template. At block 301, a dialog box containing the pages to be added is displayed. The user selects a page at 302. The page is inserted into the page array after the current page at 303, and then switch to the new page at 304. After this block 205 waits for new events.
AssistanceButton_Click( ) at block 310: This button is visible for the main role if the number of roles is greater than 1 for level 0. When this button is clicked, a dialog box is displayed with all other level 0 roles to be assigned at 311. At block 312, the main role user assigned users to all other level 0 roles; the form processor creates processes for all assigned roles and set the active property to false for support role processes. Other main roles, if there are any, remain active. The main role may also assign users without a role for level 0. These assigned users get permission to work on the section no roles assigned, that is, sub-level 0. The main role can also assign users to perform the main role's task. In the later two cased, no process will be create. The assigned users can login the as the main role to perform assigned tasks. At block 313, sub-level 1 processes, if sub-level 1 exists, are set to be active for the assigned users to work on the form instance, and the users for level 0 sub-level 1 and user authorized to perform tasks for the main role are notified for the assigned task at 314, then go back to 205 waiting for new events.
SubmitButton_Click( ) at block 320: When this event is triggered, the function SaveForm( ) in FIG. 12 is called with true as the parameter value. The return value is tested at block 321. When true is passed to function SaveForm( ), completion is checked for all input for the current role at 445 and 447 of FIG. 12. If any required input is not empty, the function returns an error message. If the returned value is empty (322), the error message is displayed at 323. Otherwise, the page is switched to view mode at 341. In either case, go back to 205 waiting for new event.
ReturnButton_Chcked( ) at block 330: when this event is triggered, the user is required to select a role to return at 331. All the inputs are for the sublevels after the target role are cleared at 332 because these inputs may be depending on the inputs for the target role. The user is asked to enter a message explaining the reason to return the form at 333, and the message is sent to the target users and all users related to this rejection at 334. The page switches to view mode at 341, and then go back to 205 waiting for new events.

A WEB Page Sample

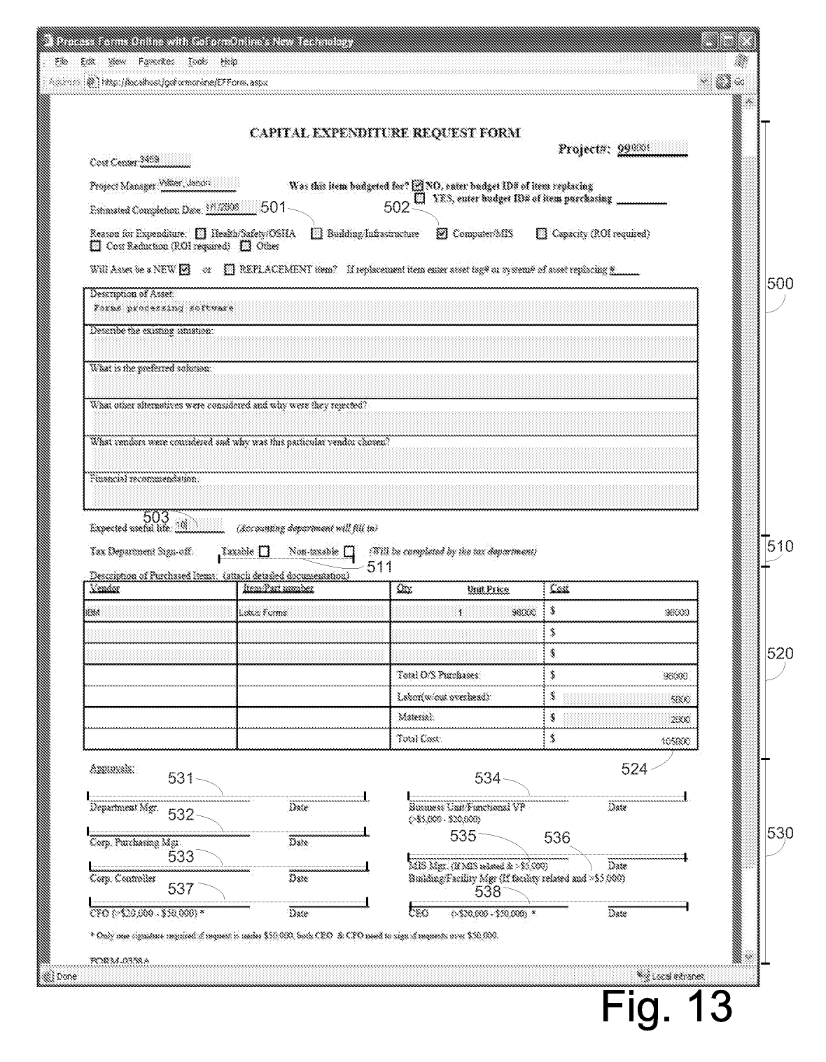

FIG. 13 shows a sample page in accordance with the present invention. The template of this page is shown in FIG. 3. This sample shows the look of the form processor web page in the edit mode, and the way to handle complicated dynamic workflow. The form in FIG. 13 is configured to have two levels. Sections 500 and 520 are for level 0; sections 510 and 530 are for level 1.

The screen-shot was developed with the main role logged in level 0. The editable controls such as input 503 have a color background. The read-only field such as 524 and the two fields at 511 do not have color background. Input 524 is read-only because it is a function of other fields in the same column. All the fields for level 1 are read-only because they are not for the main role to process.

Level 1 contains 9 roles in 4 sub-levels. Table 1 summarizes the level 1 roles. For simplicity, the numbers in FIG. 13 are used as identifier of the roles.

TABLE 1
Summary of the level 1 roles for the sample form in FIG. 13

| | Role | Sub- | | |
|---|---|---|---|---|
| Role | Type | Level | Role Condition | User Condition |
| 511 | Support | 1 | | |
| 531 | Approval | 2 | | Form initiator's |
| | | | | department |
| | | | | manager |
| 532 | Approval | 2 | | |
| 533 | Approval | 2 | | |
| 534 | Approval | 3 | Total > $5,000 and Total <= $20,000 | Responsible for the |
| | | | | form initiator's |
| | | | | department |
| 535 | Approval | 3 | Total > $5,000 and 502 is checked | |
| 536 | Approval | 3 | Total > $5,000 and 501 is checked | |
| 537 | Approval | 4 | Total between $20,000 and $50,000 and CEO did not sign, or | |
| | | | Total > $50,000 | |
| 538 | Approval | 4 | Total between $20,000 and $50,000 and CFO did not sign, or | |
| | | | Total > $50,000 | |

The workflow for the sample form with a total amount $106,000 is described as following:
After the main role submits the form, a process for role 511 is created and group member(s) for role 511 are notified.
A group member for role 511 logins and checks either “Taxable” or Non-Taxable”, then passes the form instance to sub-level 2. The “Pass” action deactivates the process for role 511, and generates active processes for roles 531, 532 and 533 and notifies the corresponding users.
The three roles for sub-level 2 can be processed in any order. Note that role 531 has a user condition, which limits the access to the department manager for the form initiator. After the three roles at sub-level 2 signed, they are deactivated and the processes for roles for sub-level 3 are generated and the corresponding users are notified.
Role 534 has a role condition of total amount between $5,000 and $20,000. For a total not in this range ($106,000 in this case), no process will be generated for this role. This role also has a user condition. Only the group members who are responsible for the form initiator's department has right to sign the form if the total meets the role condition. Roles 535 and 536 share the same space on the form for signature. If the amount is greater than $5,000 and 501 or 502 is checked, one of the two roles 535 and 536 needs to sign. In this case, the CheckBox at 502 is checked and an active process for 535 is generated. This is the only role needed to approve the form for sub-level 3.
After role 535 signs the form, the process for role 535 is deactivated and the form is passed to sub-level 4. Because the total is greater than $50,000, both 537 and 538 need to sign. Thus, two active processes are generated, and the corresponding users are notified.
Role 537 and 538 can sign the form in any order. After role 537 and 538 sign the form, the two processes are deactivated and the form is completed. This ends the workflow for this form instance.

WEB Page for Processing Applications

This page is based on the web page for processing forms with the following additional features and functionalities:
Navigation buttons in the toolbar for switching to the first form, the last form, the previous form and the next form.
ComboBox in the toolbar for selecting form to work on.
Automatically save a form before switching to another form.
The processing level in all forms containing this level must be completed before submitting or passing to the next level.

The current invention discloses an online forms processing system which can handle all types of paper and e-forms without any problems with the existing HTML or file-based forms applications. To be able to handle forms in any format, the current invention uses a basic form format which satisfies the following conditions:
The document has the identical look on the computer screen and on the paper printout.
Any form can be converted to this format.
Application Programming Interface (API) is provided for generating form images and for filling the form template with data.

At this time, PDF is the best choice as the basic form. It crosses platforms; it is extremely popular due to the free Acrobat Reader, and many government offices, enterprises and organizations have adapted PDF as the standard electronic form format. However, the current invention is not limited to the PDF format. Any form format that meets the three conditions can be used to implement a form processing system with the methods in this invention.

### ADVANTAGE SUMMARY

In summary it will be appreciated that the present invention overcomes the prior art shortcomings of processing forms with fixed format online by:
1. Generating form images the same way as the adapted e-form (or with the e-form SDK)
2. Overlaying data-bound dynamic controls or fields over the form image
3. Dynamic controls with UI indication for edit mode, and identical look with the e-form on paper in the view mode for printing
4. The content of a control is extendable to another control to avoid scroll-bar

In addition, the invention provides Role and Level-based Dynamic workflow with notification (not by routing which is for prior art file-based form processing application, but by granting permission for dynamic fields in sub-levels to users in sequence)

For each sub-level in sequential order, create an active process object for each role with the role condition to be true

Users satisfying the user condition arc assigned to the roles for the current sub-level and are notified

The notified users login the system and process the corresponding section for the role in any order

The process object is deactivated when a user completes a section for his role,

The form is completed if there are no active process objects, and no active processes to be created for the any sub-level

Form completion with default values for different uses at different stages of the workflow (FIG. 8)

Fill the dynamic control with the default value for the current user if the corresponding database field is null.

Print forms with a template-filling technology via the e-form's SDK

Process forms in group and not allow submission until all forms arc completed

Provide Application Programming Interface (API, see FIG. 7) for single sign-on to simplify web system integration

It should be understood that the foregoing description is only illustrative of the invention. Various alternatives and modifications can be devised by those skilled in the art without departing from the invention. For example, processing forms online with fixed form format or with the same look on the screen as on the paper may include:
Dual-look (editable and read-only) and extendable WEB controls.
Role-based security.
Role and level-based, sequential/parallel and dynamic workflow.
Partial form completion for multiple users.
Simplified single sign-on form system integration.
Conditional inputs or input sections.
An all-or-none way for form group submission online
   Accordingly, the present invention is intended to embrace all such alternatives, modifications and variances which fall within the scope of the appended claims.

What is claimed is:

1. A form processing system for processing electronic forms (e-form) while preserving the e-form fixed format, the form processing system comprising;
a repository subsystem, wherein the repository subsystem comprises:
an e-form repository for generating at least one page image, wherein the at least one page image comprises a plurality of e-form static data fields;
a system data repository;
a designer subsystem for designing form templates, managing permissions and assigning workflow to at least one form designer associated with the e-form, wherein the designer sub-system comprises:
a data layer generator for generating and storing in the system data repository a plurality of dynamic data fields, wherein each of the plurality of dynamic data fields have a one-to-one correspondence with each of the plurality of e-form static data fields to form at least one data layer,
a form processor subsystem wherein the form processor subsystem comprises:
an edit subsystem for users to enter data and to execute workflow; and
a viewing subsystem for viewing the at least one page image and the at least one data layer, wherein each of the plurality of dynamic data fields having a one-to-one correspondence with each of the plurality of e-form static data fields are visually overlayed with its corresponding e-form static data field.

2. The form processing system as in claim 1 wherein the repository subsystem further comprises a form data repository comprising a plurality of user input data, wherein at least one of the plurality of user input data corresponds with at least one of the plurality of dynamic data fields.

3. The form processing system as in claim 1 wherein the repository subsystem further comprises a form data repository comprising a plurality of security data, wherein at least one of the plurality of security data corresponds with at least one of the plurality of dynamic data fields.

4. The form processing system as in claim 1 wherein the repository subsystem further comprises a form data repository comprising a plurality of workflow data; wherein at least one of the plurality of workflow data corresponds with at least one of the plurality of dynamic data fields.

5. The form processing system as in claim 4 further comprising at least one workflow notifier associated with at least on of the plurality of workflow data.

6. The form processing system as in claim 5 wherein the at least one workflow notifier comprises at least one e-mail workflow notifier.

7. The form processing system as in claim 1 wherein the repository subsystem further comprises a user data repository comprising a plurality of user identification data, wherein at least one of the plurality of user identification data corresponds with at least one of the plurality of dynamic data fields.

8. The form processing system as in claim 1 wherein the repository subsystem further comprises a default value data repository comprising a plurality of default value data, wherein the plurality of default value data are connectable with at least one of the plurality of dynamic data fields.

9. The form processing system as in claim 8 wherein at least one of the plurality of default value data corresponds with at least one of the plurality of user identification data.

10. A system for generating a plurality of dynamic data field objects corresponding to a plurality of static data fields in fixed electronic forms (e-form), the system comprising:
a template designer subsystem, wherein the template designer comprises:
a data layer generator for generating the plurality of dynamic data field objects, wherein each of the plurality of dynamic data field objects have at least a one-to-one correspondence with each of the plurality of e-form static data fields to form at least one image data layer.
a repository subsystem comprising an e-form repository for retrieving e-form information and generating the at least one image layer; and
a form processor subsystem comprising a viewing subsystem for viewing the plurality of static data fields and the at least one object image data layer, wherein each of the plurality of dynamic data field objects having at least a one-to-one correspondence with each of the plurality of e-form static data fields are visually overlayed with its corresponding e-form static data field.

11. The system as in claim 10 wherein the repository subsystem further comprises:
a system data repository; and
a user data repository comprising a plurality of user identification data, wherein at least one of the plurality of user identification data corresponds with at least one of the plurality of dynamic data field objects.

12. The system as in claim 10 wherein the form processor subsystem further comprises an edit subsystem for users to enter data and to execute workflow.

13. The system as in claim 10 further comprising at least one network adaptable to joining the system with at least one form user.

14. A method for processing fixed electronic forms (e-form) having a plurality of static data fields, the method comprising:
generating an image replica of the e-form;
designing at least one form template, wherein designing at least one form template comprises:
generating a plurality of dynamic data field objects having at least a one-to-one correspondence with each of the plurality of static data fields, wherein generating the plurality of dynamic data field objects further comprises:
assigning each of the plurality of dynamic data field objects at least one control parameter;
assigning each of the plurality of dynamic data field objects at least one security parameter;
assigning each of the plurality of dynamic data field objects at least one workflow parameter;
assigning each of the plurality of dynamic data field objects at least one e-form coordinate corresponding to its corresponding static data field object;
assigning each of the plurality of dynamic data fields at least one user data;
processing each of the plurality of dynamic data field objects according to its associated parameters, wherein processing each of the plurality of dynamic data field objects further comprises:
dynamically enabling/disabling each of the plurality of dynamic data field objects according to its associated workflow parameter;
populating each of the plurality of dynamic data field objects with an associated default value;
generating an electronic notification when the dynamic data field process is complete; and
displaying the image replica and each of the plurality of dynamic data field objects according to its at least one e-form coordinate.

15. The method as in claim 14 wherein generating the plurality of dynamic data field objects further comprises:
storing the at least one control property in a system repository.

16. The method as in claim 14 wherein generating the plurality of dynamic data field objects further comprises:
storing the at least one security parameter in a form data repository;
storing the at least one user input data in the form data repository; and
storing the at least one workflow parameter in the form data repository.

17. The method as in claim 14 wherein assigning each of the plurality of dynamic data field objects at least one security parameter further comprises associating the at least one security parameter with at least one user.

18. The method as in claim 14 wherein assigning each of the plurality of dynamic data field objects at least one workflow parameter further comprises associating the at least one workflow parameter with at least one user.

19. The method as in claim 14 wherein designing at least one form template further comprises allowing an attachment to be associated with the e-form.

20. The method as in claim 14 further comprising printing the plurality of dynamic data field objects, wherein printing the plurality of dynamic data field objects comprises printing the e-form and each of the plurality of dynamic data field objects according to its at least one e-form coordinate
